(19) United States
(12) Patent Application Publication
(10) Pub. No.: US 2026/0160031 A1
(43) Pub. Date: Jun. 11, 2026

(54) GROUND CRUSHING MACHINE FOR CRUSHING A SOLID GROUND

(71) Applicant: Hamm AG, Tirschenreuth (DE)

(72) Inventor: Günter RATH, Krummennaab (DE)

(21) Appl. No.: 19/413,579

(22) Filed: Dec. 9, 2025

(30) Foreign Application Priority Data
Dec. 11, 2024 (DE) 102024137058.0

(51) Int. Cl. E01C 23/12; B02C 21/02

(52) U.S. Cl. CPC E01C 23/124; B02C 21/026; B02C 2021/023

(57) ABSTRACT

A ground crushing machine for crushing a solid ground comprises a machine frame (12) that can be moved on the ground (38) to be crushed by means of a chassis and a crushing unit (24) supported on the machine frame (12), comprising a crushing assembly (42) to be brought into contact with the ground (38) in order to crush the ground (38), and a crushing assembly drive (52) for generating a crushing force acting on the crushing assembly (42) for crushing the ground (38). The crushing assembly drive (52) is configured to generate a crushing force with a periodically varying force magnitude and a substantially unchangeable force direction.

The present invention relates to a ground crushing machine with which a solid ground, for example a concrete slab or the like, can be crushed.

A ground crushing machine according to the preamble of claim 1 is known from DE 10 2017 129 932A1. This ground crushing machine, constructed in the manner of a self-propelled ground compactor, comprises a ground processing roller designed to crush a solid ground, which roller is rotatable about a roller rotation axis and comprises on its outer circumference a plurality of ground processing bars extending in the direction of the roller rotation axis. When driving over the solid ground to be crushed, the ground processing bars arranged on the outer circumference of the ground processing roller with equal circumferential spacing from each other come into contact with the ground to be crushed and crush it due to the resulting load. A vibration generating mechanism arranged inside the ground processing roller and operating in the manner of a vibration mechanism can cause the ground processing roller to vibrate so that the load applied to the solid ground to be crushed can be increased.

A ground crushing machine is known from U.S. Pat. No. 4,439,056 in which a plate-like shoe used to crush a solid ground is subjected to pressure by a hammer-like mechanism against the ground to be crushed. The hammer-like mechanism has a combustion chamber into which air and fuel are introduced in the manner of a diesel (internal combustion) engine. When this mixture is ignited, the increasing pressure generates a force which is transferred to the shoe which is pressed against the ground in order to crush it.

It is the object of the present invention to provide a ground crushing machine for crushing a solid ground with which a solid ground to be crushed can be reliably broken up into defined, predefined pieces.

According to the invention, this object is achieved by a ground crushing machine for crushing a solid ground, comprising:
a machine frame movable by means of a chassis on the ground to be crushed,
a crushing unit supported on the machine frame, comprising a crushing assembly to be brought into contact with the ground in order to crush the ground, and a crushing assembly drive for generating a crushing force acting on the crushing assembly for crushing the ground.

The crushing assembly drive is configured to generate a crushing force with a periodically varying force magnitude and a substantially unchangeable force direction.

The crushing assembly, which is subjected to a periodically changing but always uniformly directed crushing force, can act on the solid ground to be crushed in the manner of a jackhammer, such that the impacts exerted on the solid ground by means of the crushing assembly can substantially crush the ground at a predefined position without generating fine particles.

In order to substantially prevent the transmission of corresponding impacts on the machine frame when the crushing assembly strikes the ground to be crushed, the crushing unit may comprise an assembly housing supported on the machine frame, wherein the assembly housing is supported on the machine frame so as to be movable at least in the force direction.

For this purpose, it may in particular be provided that the assembly housing is supported on the machine frame by means of an elastic suspension.

Taking into account the loads occurring during crushing operation, it is advantageous if the suspension comprises a plurality of springs, for example steel springs configured as helical springs. In order to generate the periodically varying crushing force directed in a defined direction with a simple structure and reliable operation, the crushing assembly drive can comprise a first unbalance mass which can be driven for rotation about a first unbalance axis of rotation in a first direction of rotation and has a first unbalance center of mass which is eccentric with respect to the first unbalance axis of rotation, and a second unbalance mass which can be driven for rotation about a second unbalance axis of rotation which is eccentric with respect to the first unbalance axis of rotation and parallel to this axis of rotation in a second direction of rotation opposite to the first direction of rotation, and has a second unbalance center of mass which is eccentric with respect to the second unbalance axis of rotation, wherein the first unbalance center of mass and the second unbalance center of mass are positioned substantially mirror-symmetrically for each rotational position with respect to a plane of symmetry which is orthogonal to a distance line between the two unbalance axes of rotation and intersects this plane centrally between the two unbalance axes of rotation. The crushing assembly drive substantially operates in the manner of a vibration generating mechanism which generates a periodically changing, directed force action on the crushing assembly and, via this, on the solid ground to be crushed.

In order to set the unbalanced masses in motion or to keep them in motion, an unbalanced drive, for example comprising at least one hydraulic motor or electric motor, can be provided which drives the first unbalanced mass and the second unbalanced mass to rotate.

In order to produce comparatively large fragments of the ground to be crushed, the crushing assembly can have a crushing section elongated in the direction of a crushing line.

For this purpose, the crushing assembly may comprise a crushing bar with a crushing edge providing the crushing section, and/or the crushing assembly may comprise a plurality of crushing elements, preferably chisel-like, arranged one after the other in the direction of the crushing line and providing the crushing section.

For efficient transmission of the crushing force to the crushing assembly, the assembly can be positioned so that the crushing line extends in the direction of the unbalance axes of rotation and is positioned substantially in the plane of symmetry.

For an easy-to-implement structure, the crushing section can be supported on the assembly housing. The number of components required for power transmission and, if necessary, also contributing to damping can thus be kept small.

In order to bring the crushing unit into an operating position or into an inoperative position, it is proposed that the assembly housing be supported on a machine frame part of the machine frame which can be moved towards and away from the ground to be crushed.

In order to move the ground crushing machine configured as a self-propelled machine over the solid ground to be crushed, the machine frame can comprise a rear-carriage machine frame and a front-carriage machine frame, which can preferably be pivoted about a steering axis with respect to the rear-carriage machine frame, wherein a drive unit and/or an operating station is provided on the rear-carriage machine frame and the crushing unit is carried on the front-carriage machine frame.

Furthermore, the chassis can comprise wheels, preferably driven wheels on the rear-carriage machine frame and preferably non-driven wheels on the front-carriage machine frame.

If the machine frame is elongated in a machine frame longitudinal direction that substantially corresponds to a direction of travel of the ground crushing machine and the crushing line is arranged substantially orthogonally to the machine frame longitudinal direction, fracture lines at which the solid ground to be crushed is broken into fragments of a defined size can be gradually created by successively moving the ground crushing machine in the direction of travel.

The present invention is described in detail below with reference to the appended figures. In particular:

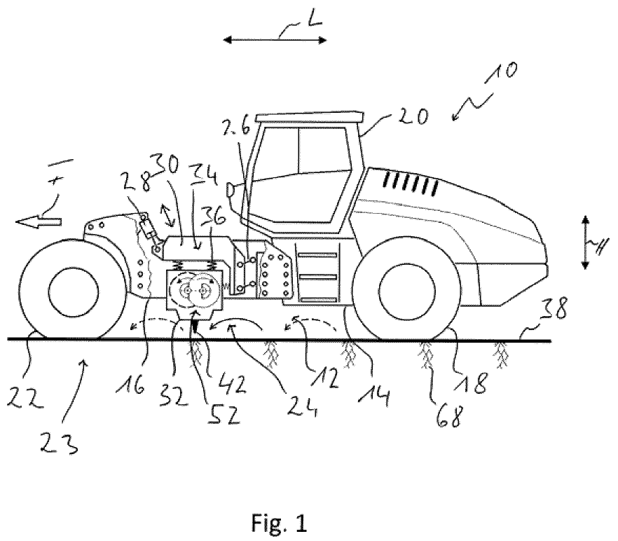

FIG. 1 shows a side view of a self-propelled ground crushing machine with a crushing unit;

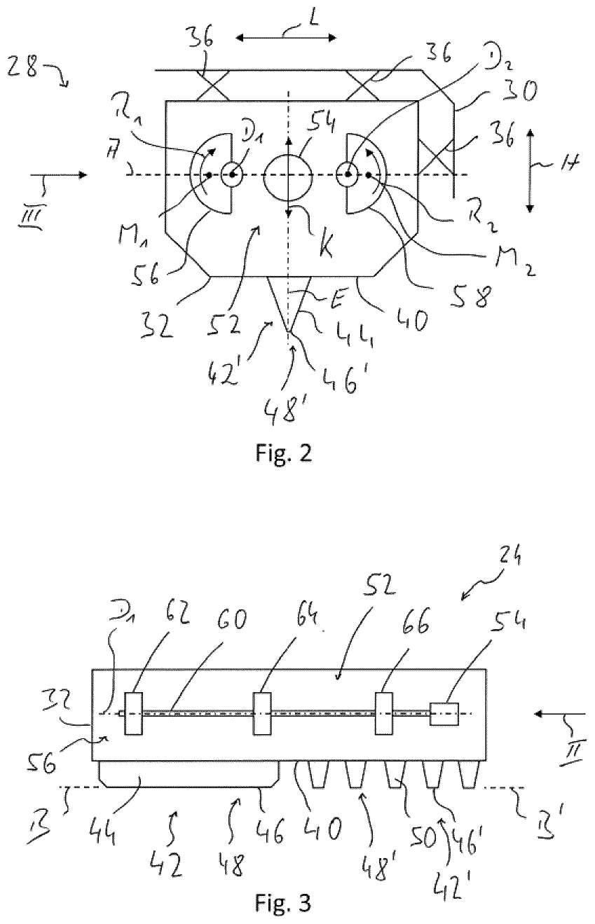

FIG. 2 shows a side view of a basic representation of the crushing unit of the ground crushing machine of FIG. 1 in viewing direction II in FIG. 3;

FIG. 3 shows a front view of the crushing unit in viewing direction III in FIG. 2.

In FIG. 1, a self-propelled ground crushing machine is generally designated by 10. The ground crushing machine 10 comprises a machine frame 12, basically comprising a rear-carriage machine frame 14 and a front-carriage machine frame 16 which is connected to the rear-carriage machine frame 14 for pivoting about a steering axis. A drive unit, for example a diesel engine or electric motor, is provided on the rear-carriage machine frame 14, by means of which drive unit drive wheels 18 likewise provided on the rear-carriage machine frame 14 are driven to rotate in order to move the ground crushing machine 10, which is elongated in a machine frame longitudinal direction L, either in a direction of travel F or opposite to the direction of travel. Furthermore, an operating station 20 in which an operator can stay to operate the ground crushing machine 10 is provided on the rear-carriage machine frame 14.

Wheels 22 of a chassis 23 are provided on the front-carriage machine frame 16, which wheels can be mounted on the front-carriage machine frame 16, for example rigidly, i.e., non-steerably. In this case, the ground crushing machine 10 is steered, for example, by pivoting the front-carriage machine frame 16 relative to the rear-carriage machine frame 14. In an alternative embodiment, the front-carriage machine frame 16 and the rear-carriage machine frame 14 can be rigidly connected to one another or form a structural unit on which the wheels 22 provided on the front-carriage machine frame 16 for steering the ground crushing machine 10 are pivotably supported, for example.

A crushing unit, generally designated 24, is supported on the front-carriage machine frame 16 in the machine frame longitudinal direction L between the wheels 22 provided on the front-carriage machine frame 16 and the wheels 18 provided on the rear-carriage machine frame 14. For this purpose, the front-carriage machine frame 16 has a machine frame part 30 which can be moved substantially in a height direction H via a joint mechanism 26 and a lifting mechanism 28, which height direction H can be substantially orthogonal to the machine frame longitudinal direction L. A box-like assembly housing 32 of the crushing unit 24 is supported on the machine frame part 30 via a plurality of coil springs 36, for example made of a steel material and providing an elastic suspension 34. By means of the elastic suspension 34, the crushing unit 24 is movably supported on the machine frame part 30 at least in the height direction H, preferably also in the machine frame longitudinal direction L.

A crushing assembly 42 is mounted on an underside 40 of the assembly housing 32 facing a ground 38 to be crushed. As shown on the left in FIG. 3, the crushing assembly 42 can comprise a substantially uninterrupted continuous crushing bar 44 which, with a crushing edge 46 directed against the ground 38 to be crushed, provides a crushing section 48 elongated in the direction of a crushing line B. The crushing line B is oriented substantially orthogonally to the machine frame longitudinal direction L and also orthogonally to the height direction H and thus extends substantially transversely to the direction of travel F over substantially the entire width of the ground crushing machine 10.

In a modified embodiment shown on the right in FIG. 3, the crushing assembly 42′ can comprise a plurality of chisel-like crushing elements 50 arranged successively in the direction of the crushing line B′, which, with crushing edges 46′ or crushing tips or the like each directed against the ground 38 to be crushed, in their entirety form the crushing section 48′ of the crushing assembly 42′. The crushing elements 50 can be detachably supported on the assembly housing 32, so that in the event that they are worn after prolonged operation, simple replacement of the individual crushing elements 50, which may have a chisel-like configuration, is possible.

In order to exert a load that crushes the ground 38 by means of the crushing assembly 42, the crushing unit 24 further comprises a crushing assembly drive 52. The crushing assembly drive 52 generates a periodically varying crushing force K, which has a direction that is, for example, unchangeable with respect to the assembly housing 32 and, in the example shown, lies in a plane of symmetry E. For this purpose, the crushing assembly drive 52 comprises a first unbalance mass 56 which can be driven by an unbalance drive 54 for rotation about a first unbalance axis of rotation Di in a first direction of rotation R₁ and has a first unbalance center of mass M₁ which is eccentric to the first axis of rotation D₁. The crushing assembly drive 52 further comprises a second unbalanced mass 58 which can be driven by the unbalanced drive 54 to rotate in a second direction of rotation R₂ opposite to the first direction of rotation R₁ about a second axis of rotation D₂ which is spaced apart from and parallel to the first axis of rotation D₁ in the direction of a distance line A. The second unbalance mass 58 has a second unbalance center of mass M₂ which is arranged eccentrically to the second axis of rotation D₂. The distance line A is substantially oriented in the direction of the machine frame longitudinal direction L.

The phase position of the two unbalance masses 56, 58 or the centers of mass M₁, M₂ of the same with respect to each other is set such that for each rotational position of the two unbalance masses 56, 58 rotating in opposite directions and at the same speed, the unbalance centers of mass M₁, M₂ of the same are positioned substantially mirror-symmetrically with respect to the symmetry plane E oriented orthogonally to the distance line A. As a result, upon rotation of the two unbalanced masses 56, 58, a crushing force K is generated in the plane of symmetry E, the orientation of which periodically changes, alternating in the height direction H downwards, i.e., towards the ground 38 to be crushed, and upwards, i.e., away from the ground 38 to be crushed. Due to this periodically changing, oscillating crushing force H, a periodically striking crushing force K is applied to the crushing assembly 42 upon contact of the crushing edge 46 with the ground 38 to be crushed, such that the crushing assembly 42 acts on the ground 38 to be crushed in the manner of a jackhammer and crushes it at a defined positioning along the crushing line B. Since the crushing unit 24 is supported on the machine frame 12 by means of the elastic suspension 34 in the ground crushing machine 10, a transmission of substantially impacting force components to the machine frame 12 is largely prevented. This increases the comfort for an operator operating an accustomed crushing machine 10.

As can be seen in FIG. 3, in order to exert a force that is substantially uniform in the direction of the crushing line B, each of the unbalance masses 56, 58 can comprise a plurality of unbalance mass parts 62, 64, 66 arranged, for example, at a uniform distance from one another on an unbalance shaft 60 extending in the direction of the respective axis of rotation D₁, D₂. The unbalance shafts 60 of the two unbalance masses 56, 58 can be driven by the unbalance drive 54, for example via a belt drive or a gear drive. The unbalance drive 54 may for example comprise a hydraulic motor that is fed from the hydraulic system of the ground crushing machine 10 and drives both unbalance masses 56, 58 to rotate. In the case of an electro-hydraulic design of the drive system of the ground crushing machine 10, the unbalance drive 54 can equally comprise a hydraulic motor, but possibly also an electric motor. Furthermore, the unbalance drive 54 can comprise a separate unbalance motor associated with each unbalance mass 56, 58.

As illustrated in FIG. 1 in connection with the first unbalanced mass 56, in order to crush the ground 38, for example a concrete slab or the like, the ground crushing machine 10 can be moved successively to predefined breaking points 68. When such a predefined breaking point 68 is reached, the ground crushing machine 10 stops and the frame part 30 is lowered from an upwardly raised inoperative position so that the crushing assembly 42 with its crushing edge 46 comes into contact with the ground 38 to be crushed. At or even before contact occurs between the crushing assembly 42 and the ground 38 to be crushed at a predefined breaking point 68, the crushing assembly drive 42 is put into operation in order to periodically apply the crushing force K to the crushing assembly 42 and thus strike against the ground to be crushed. Force transmission is particularly efficient because, as can be seen in FIG. 2, the crushing edge 46 or the crushing line B lies substantially in the plane of symmetry E.

Since the assembly drive 52 is in principle only to be operated when the crushing assembly 42 is in contact with the ground 38 to crush it, and in these phases the ground crushing machine 10 is stationary, i.e., no energy is required to move it over the ground 38, the drive unit provided for supplying energy to the ground crushing machine 10 can be comparatively small in size and yet supply a relatively large amount of energy to drive the crushing assembly 42 in ground crushing operation.

If a sensor system is provided on the ground crushing machine 10, which sensor system provides information representing the positioning of the machine on the ground 38 to be crushed, it is possible to carry out the operation of the ground crushing machine 10 substantially automatically. For example, a GPS system can be used to provide this position information, and, using a predefined plan for the location of the predefined breaking points 68, this information can be used to move the ground crushing machine 10 successively to these predefined breaking points 68 and to perform a ground crushing operation there. Such automated operation of the ground crushing machine 10 also makes it possible, taking into account known data on the condition of the ground 38 to be crushed, to adapt the ground crushing operation to possibly changing conditions across the ground 38, for example a changing thickness of the ground 38 to be crushed. The energy provided to the ground crushing machine 10 can thus be optimally adapted to the ground crushing operation to be carried out.

In the ground crushing machine 10, it may further be provided that the crushing unit 24 can be pivoted, for example, about an axis parallel to the axes of rotation D₁ or D₂, in order to change the direction in which the crushing assembly 42 acts on the ground 38 to be crushed, such that the direction in which the crushing unit 42 acts on the ground 38 to be crushed, i.e., the force direction K, is not oriented exactly in the height direction H, for example, but can be set, as the case may be, in the direction of travel F or opposite thereto.

1. A ground crushing machine for crushing solid ground, comprising:
a machine frame movable via a chassis on the ground to be crushed,
a crushing unit supported on the machine frame , comprising a crushing assembly to be brought into contact with the ground in order to crush the ground , and a crushing assembly drive for generating a crushing force acting on the crushing assembly for crushing the ground ,
wherein the crushing assembly drive is configured to generate a crushing force with a periodically varying force magnitude and a substantially unchangeable force direction.

2. The ground crushing machine of claim 1,
wherein the crushing unit comprises an assembly housing supported on the machine frame , wherein the assembly housing is supported on the machine frame so as to be movable at least in the force direction.

3. The ground crushing machine of claim 2,
wherein the assembly housing is supported on the machine frame by an elastic suspension.

4. The ground crushing machine of claim 3,
wherein the suspension comprises a plurality of springs.

5. The ground crushing machine of claim 1
wherein the crushing assembly drive comprises a first unbalance mass which is drivable for rotation about a first unbalance axis of rotation in a first direction of rotation and has a first unbalance center of mass which is eccentric with respect to the first unbalance axis of rotation, and a second unbalance mass which is drivable for rotation about a second unbalance axis of rotation which is eccentric with respect to the first unbalance axis of rotation and parallel to this axis of rotation in a second direction of rotation opposite to the first direction of rotation, and has a second unbalance center of mass which is eccentric with respect to the second unbalance axis of rotation, wherein the first unbalance center of mass and the second unbalance center of mass are positioned substantially mirror-symmetrically for each rotational position with respect to a plane of symmetry which is orthogonal to a distance line between the two unbalance axes of rotation and intersects this plane centrally between the two unbalance axes of rotation

6. The ground crushing machine of claim 5,
wherein an unbalance drive is provided which drives the first unbalance mass and the second unbalance mass to rotate.

7. The ground crushing machine of claim 1,
wherein the crushing assembly has a crushing section which is elongated in the direction of a crushing line.

8. The ground crushing machine of claim 7,
wherein the crushing assembly comprises a crushing bar with a crushing edge providing the crushing section, and/or the crushing assembly comprises a plurality of crushing elements which are arranged one after the other in the direction of the crushing line, and providing the crushing section.

9. The ground crushing machine of claim 7,
wherein the crushing assembly drive comprises a first unbalance mass which is drivable for rotation about a first unbalance axis of rotation in a first direction of rotation and has a first unbalance center of mass which is eccentric with respect to the first unbalance axis of rotation, and a second unbalance mass which is drivable for rotation about a second unbalance axis of rotation which is eccentric with respect to the first unbalance axis of rotation and parallel to this axis of rotation in a second direction of rotation opposite to the first direction of rotation, and has a second unbalance center of mass which is eccentric with respect to the second unbalance axis of rotation, wherein the first unbalance center of mass and the second unbalance center of mass are positioned substantially mirror-symmetrically for each rotational position with respect to a plane of symmetry which is orthogonal to a distance line between the two unbalance axes of rotation and intersects this plane centrally between the two unbalance axes of rotation, and
wherein the crushing line extends in the direction of the unbalance axes of rotation and is substantially positioned in the plane of symmetry.

10. The ground crushing machine of claim 7,
wherein the crushing unit comprises an assembly housing supported on the machine frame, wherein the assembly housing is supported on the machine frame so as to be movable at least in the force direction, and
wherein the crushing section is supported on the assembly housing.

11. The ground crushing machine of claim 2,
wherein the assembly housing is supported on a machine frame part of the machine frame which is movable towards and away from the ground to be crushed.

12. The ground crushing machine of claim 1,
wherein the machine frame comprises a rear-carriage machine frame and a front-carriage machine frame which is optionally pivotable about a steering axis with respect to the rear-carriage machine frame, wherein a drive unit and/or an operating station is provided on the rear-carriage machine frame and the crushing unit is supported on the front-carriage machine frame.

13. The ground crushing machine of claim 12,
wherein the chassis comprises wheels, including driven wheels on the rear-carriage machine frame and non-driven wheels on the front-carriage machine frame.

14. The ground crushing machine of claim 9,
wherein the machine frame is elongated in a machine frame longitudinal direction substantially corresponding to a direction of travel of the ground crushing machine, and in that the crushing line is arranged substantially orthogonally to the machine frame longitudinal direction.
